(19) United States
(12) Patent Application Publication
(10) Pub. No.: US 2001/0027817 A1
(43) Pub. Date: Oct. 11, 2001

(54) Modular manifold for heating and sanitary systems

(76) Inventor: Mario Giacomini, S. Maurizion D'Opaglio (IT)

Correspondence Address: YOUNG & THOMPSON, 745 SOUTH 23RD STREET 2ND FLOOR, ARLINGTON, VA, 22202

(21) Appl. No.: 09/770,457

(22) Filed: Jan. 29, 2001

(30) Foreign Application Priority Data
Mar. 20, 2000 (EP) PCT/EP00/02435

(51) Int. Cl. F17D 1/00

(52) U.S. Cl. 137/884

(57) ABSTRACT

An improve modular manifold (40) for heating and sanitary systems comprising tubular manifold modules (21; 50, 51, 60, 61; 70, 71, 80) having integrally formed end coupling means (22, 23; 53, 54) and either only a branch union (4) or a branch union (4) and an adjusting union (3) for receiving a branched circuit pipe and a shutter mechanism (62), respectively. Metal pre-shaped blanks (1) are provided for producing said manifold modules (21; 50, 51, 60, 61; 70, 71, 80) by hot-pressing and chip-forming machining steps. Plastics manifold modules (21; 50, 51, 60, 61; 70, 71, 80) may also be injection molded.

### TECHNICAL FIELD OF THE INVENTION

The present invention relates to improved modular manifolds for heating and sanitary systems, to manifold modules and module blanks according to the pre-characterizing part of claims 1, 13 and 16.

The present invention also relates to a method for manufacturing said blanks according to the preamble of claim 20.

### BACKGROUND OF THE INVENTION

It is known that in heating and sanitary systems one-piece manifolds are used for branching from a feed conduit a plurality of heating or water distributing circuits as well as for collecting the outlets of said circuits and conveying the latter into the return conduit of the heating or water distributing system.

The known one-piece manifolds have a tubular body with a plurality of union couples formed by an adjusting union, containing a shutter with an external control knob, and a branch union, respectively. Said adjusting and branching unions are in fluid communication with the through conduit of the manifold and an interception port co-operating with the shutter associated therewith.

The known one-piece manifolds are known in several embodiments and are generally housed in distribution boxes to be embedded under plaster. A first embodiment has a manifold body obtained from an extruded profiled metal bar in which for each branched circuit are drilled two diametrically opposite threaded holes or union couple housing the one an adjusting union and the other a branching union. In spite of the easy manufacturing of the profiled bars, the manifolds of this type are affected by several drawbacks.

First of all said bars, as well as the bar segments cut with different lengths for forming different long manifolds, have a high weight, and secondly for meeting the needs of manifolds having different lengths and from 2 up to, for example, 12-15 union couples for the same number of branched circuits is necessary a correspondingly expensive stock-keeping Furthermore are also known manifolds produced by metal casting, which have the adjusting and branching unions integrally formed with the tubular manifold body. Although the casting manifolds present an easy machining with machine tools also said casting manifolds are affected by several shortcomings. Similarly to the manifolds obtained from bars by chip-machining also the manifolds obtained by metal casting require an expensive stock-keeping for meeting the different needs concerning the number of unions needed for the branched circuits to be connected with the latter.

As a typical feature of casting pieces in general also the manifolds have a body with a structure which is rather porous and, indirectly, not airtight. One measure for trying to overcome said shortcoming is to increase the thickness of the manifold body. However, said measure, on the one end does not totally eliminate the airtight problem and, on the other hand, considerably and disadvantageously increases the manifold weight. As a further peculiarity of the metal castings the known manifolds also have rather low strengths, which also leads to increase the manifold thickness. Furthermore, as an additional peculiarity of the metal castings, in the latter there are frequently recesses, holes and internal deformations.

A further disadvantage of the casting manifolds is to be seen in the typical internal roughness. Said roughness favors an easier fouling deposit which in turn increases the loss of pressure due to friction. This aspect is particularly disadvantageous because it considerably reduces the efficiency of the heating and sanitary circuits.

In order to reduce the manifold stock-keeping costs it has become known to produce composite manifolds formed by modular elements or modules made of plastics and having each two or three union couples for a corresponding number of branched circuits. The ends of said modular elements are provided with abutment flanges in order to allow a connection in line of a plurality of said modular elements for forming a modular manifold having the desired number of union couples for the desired branched circuits. Said modular elements are connected by means of a plurality of screws housed in circumferencially distributed through holes in said module end flanges. In each modular element the adjusting and branch unions provided for each branched or secondary circuit are coaxial and offset with respect to the middle longitudinal axis of the modules.

In an alternate embodiment of modular elements the adjusting and branch unions of a union couple for connecting a branched circuit are provided in a disposition at right angle. This disposition is generally preferred in the case of a manifold installation in distribution boxes. However, beside the simplification obtained in the stock-keeping also these modular elements produced by injection molding substantially present the same drawbacks mentioned above with reference to the metal manifolds produced by casting.

Furthermore, the assembling of said plastics manifolds is time-consuming and require the use of tools.

An embodiment of a manifold module for assembling composite manifolds for heating and sanitary systems has been described by the applicant in the Italian patent application CO99A000003, filed on Nov. 1, 1999 and not yet published.

### SUMMARY OF THE INVENTION

It is an object of the present invention to solve the problems of the prior art and enable modular manifold to be simply and quickly assembled with modular elements which do not require fixing components which may be lost, have a low loss of pressure due to friction, have a reduced weight when made of metal, may be assembled without tools, may also be produced with small diameters, and also allow the assembling of manifold having a low number of union couples.

Another object of the invention is to suggest a method for producing metal blanks which are fit to be simply and quickly machined with known automatic machine tools or machining centers to obtain modular elements having a reduced weight.

The above stated objects are achieved according to the invention with modular manifolds, manifold modules and blanks module according to the indipendent claims 1, 13 and 16.

An advantageous method for producing said metal blanks is stated in claim 20.

Further embodiments of said modular manifolds, manifold modules and module blanks are inferable from the dependent claims.

Many advantages may be obtained with the composite manifolds, manifold modules and blanks according to the present invention. A first advantage is that it is possible to manufacture metal modules having a small wall thickness of the module body and a short length thereof, so that the module weight is substantially reduced. Another advantage is that the manifold may be assembled without tools and that the assembling time is drastically reduced in comparison with the known composite manifolds. Still another advantage is that the proposed manifolds modules may be produced either in metal or in plastics. The suggested quick coupling means assure a perfect tightness witout any banana-deformation even with long manifold and high pressure values. Some embodiments have a conformation assuring a considerably reduction of the loss of pressure in the manifold due to friction.

With the suggested embodiments it is also possible to connect the composite manifold to heating or sanitary pipes having either the same diameter as the manifold or a smaller one. It is also possible to quickly connect the manifold branch unions with all types of branched circuit pipes such as metal pipes, plastics pipes, multilayer pipes and so on. Metal and plastics modules may also be quickly connected together.

### BRIEF DESCRIPTION OF THE DRAWINGS

FIG. 1 is a perspective view of a blank according to the present invention;

FIG. 2 is a front view as seen in the direction of arrow A in FIG. 1;

FIG. 3 is a section taken along the plane III-III of FIG. 5;

FIG. 4 is a section taken along the plane IV-IV of FIG. 2;

FIG. 5 is a view as seen in the direction of arrow B in FIG. 2;

FIGS. 5A and 5B are views similar to FIG. 5, showing two different embodiments;

FIG. 6 is a section taken along the plane VI-VI of FIG. 2;

FIGS. 7 to 12, as well as 11A and 11B are views showing modules for manifolds obtained from blanks according to FIGS. 1 to 6, as well as 5A and 5B, and corresponding to the latter,

FIG. 13 shows two manifold modules assembled to form a manifold for two not shown branched circuits, and more specifically in the longitudinal lower Figure-half in a front view, and in the longitudinal uppegure-half in a sectional view in the middle vertical plane;

FIGS. 14 and 15 are sectional views taken along the longitudinal middle plane of a right and left end modules, respectively, which have a branch union only and may be connected together to form a manifold for two branched circuits;

FIG. 16 is a perspective view of both end modules of FIGS. 14 and 15 before the connection thereof;

FIG. 17 is a sectional view taken along the longitudinal middle plane of a basis or internal manifold module which has a branch union only and may be connected indifferently with another basis module or with end modules as shown in FIGS. 14 and 15;

FIG. 18 is a sectional view taken along the longitudinal middle plane of another embodiment of the basis module of FIG. 17, however with a branch union housing a known fixing means for clamping the inserted branched circuit pipe, not shown;

FIG. 19 is a perspective view showing the basis module of FIG. 18 in an exploded view;

FIGS. 20 and 21 are sectional views taken along a longitudinal middle plane of two manifold end modules, respectively, of the type shown in FIGS. 7 to 13, however with different coupling means;

FIG. 22 is a sectional view taken along the longitudinal middle plane of a basis or internal manifold module provided for the use with the manifold end modules of FIGS. 20 and 21;

FIG. 23 is a sectional view along the plane XXIII-XXIII of FIG. 22; and

FIG. 24 is a perspective view showing a composite manifold formed by connecting two end modules and two basic modules according to FIGS. 14, 15 and 17, respectively.

### DETAILED DESCRIPTION OF THE INVENTION

In thgures equal or equivalent parts are denoted by equal nemeral references.

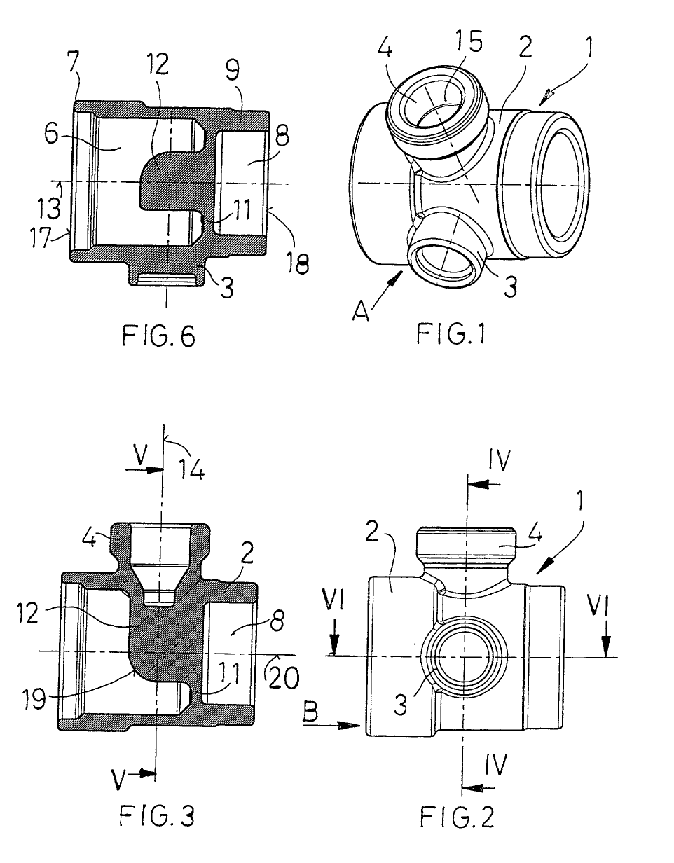

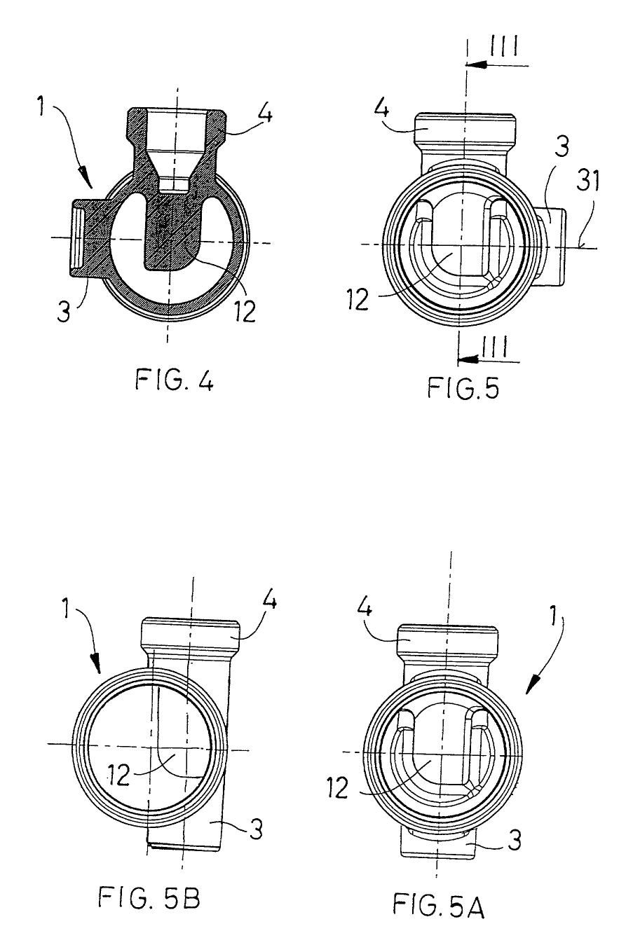

Reference is first made to FIGS. 1 to 6 showing a first embodiment of a blank for producing manifold modular elements or modules described with more details in the following. According to the invention said blank is obtained by means of a hot-pressing phase starting from a semi-finished piece in the form of a not shown solid metal cylinder, for example made of brass.

The blank is generally denoted by 1 and has a tubular body 2 comprising a first union 3 referred to as an adjusting union and a second union 4 referred to as a branch union, said unions being integrally with the blank body and, in the shown embodiment, dead ones.

As can be seen in particular in FIGS. 3 and 6 the tubular body 2 has at a first end 7 thereof a first cup-like chamber 6 openings towards the exterior and at a second end 9 of said tubular body 2 the latter is provided with a second cup-like chamber 8 also openings towards the exterior, which chambers 6 and 8 are separated by a transversal partition wall or diaphragm 11. In the first chamber 6 between said diaphragm 11 and said branch union 4 the blank body has an integral internal projecting part or boss 12. In the shown example said projecting part 12 extends substantially in the vertical longitudinal middle plane 13 of the blank 1, FIG. 6.

According to the present invention the diaphragm 11 is provided downstream of the vertical axis 14 of the branch union 4 (FIG. 3) and, in the shown example, substantially downstream of said branch union 4 itself. Furthermore, in the shown example the axes of the adjusting union 3 and the branch union 4 are provided orthogonally the one with respect to the other and lie in a common plane 15 which is transversal with respect to the tubular body 2.

As can be seen in particular from the FIGS. 3 and 6, the wall thickness of the tubular body 2 in the longitudinal direction shows a substantially step-like configuration, is substantially thin, and has a thickness in the range of a few mm, for example between 2 and 4 mm in the case of blanks 1 for modular elements having a diameter of ¾″ and 1″.

The position and the thickness of the diaphragm 11 are such that the removal thereof, for example by means of a turning step, creates a connection between said first and second chambers 6 and 8, thereby forming a through duct 16 connecting the inlet and outlet ports 17 and 18, FIG. 9.

The free end 19 of the internal boss 12 of the examples shown in FIGS. 1 to 6 extends from the branch union 4 beyond the middle horizontal longitudinal plane 20 of the blank 1.

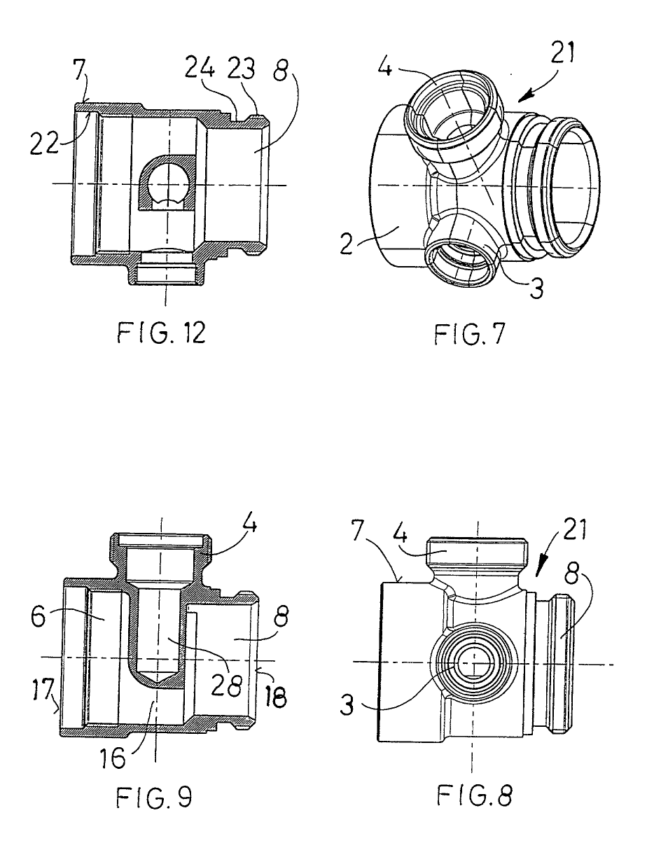

The modular element 21 for manifolds according to the present invention shown in the FIGS. 7 to 13 has a basis configuration which is similar to that of the blank I from which it is obtained, thereby the final shape of said modular element 21 is advantageously obtained by means of easy and quick known chip-forming machining operations like turning, drilling, and threading, which can be automatically made in automatic machine tools or machining centers.

The modular element 21 is provided for branching only one not shown branched circuit, and it is, therefore, referred to as a single-couple module or single circuit module, whereby said term single-couple module is referred to a couple formed by the branch union 4 and the adjusting union 3.

Beside the removal of the transverse diaphragm 11 the modular element 21 will undergo a turning/threading machining of both ends 7 and 9 thereof for forming a connecting means for a mutual connection of two consecutive modules 21, as well as an external turning for forming the step-like configuration shown in the drawings.

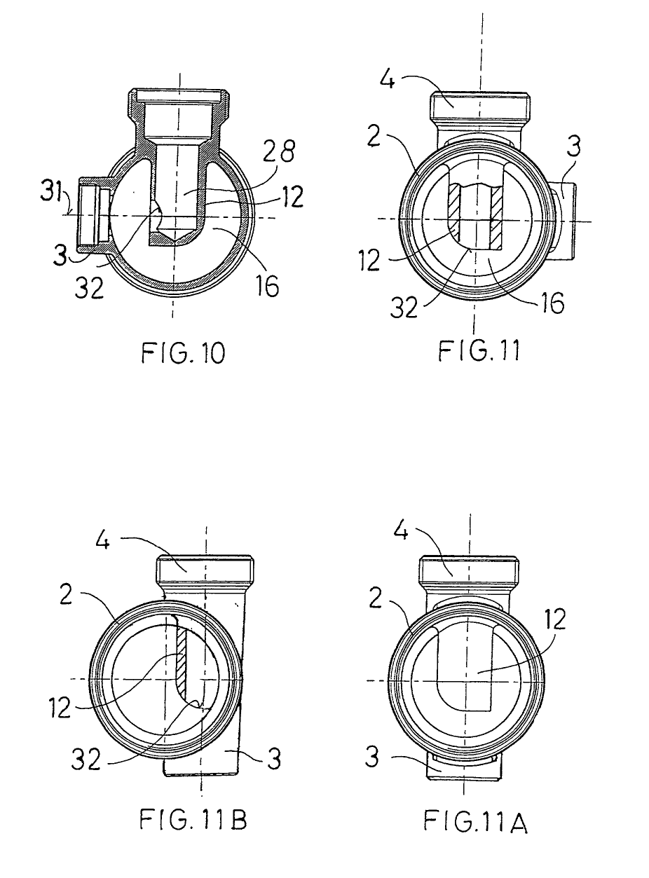

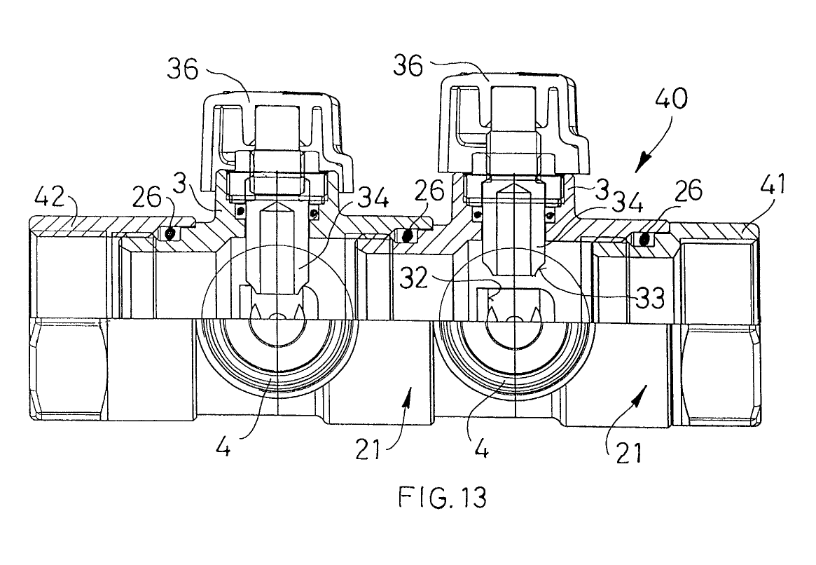

In the embodiment shown in FIGS. 7 to 13 the first end 7 is internally threaded to form a female threaded union 22 whereas the end 9 will be externally threaded to form a male threaded union 23 as shown in FIG. 12. The numeral 24 denotes a groove or seat for housing a gasket or washer, for example an O-ring 26, FIG. 13. The branch union 4 is internally threaded and then drilled to first form a dead hole 28, FIG. 9. The adjusting union 3 is in turn threaded and then through drilled along the axis 31, FIG. 10, whereby through said adjusting union 3 is further drilled the internal projecting boss 12 until reaching the inside thereof, that is until opening in the dead hole 28, in order to form in said internal boss 12 an interception port 32, FIGS. 10 and 13. With the latter co-operates the free end 33 of the shutter 34 which is externally controllable in a known manner by means of a knob 36, FIG. 13, in which one shutter 34 is in a closed position and the other shutter 34 is in an open position.

In the embodiment shown in FIG. 13 the modular manifold 40 is terminated at both ends thereof with a male and a female ring nut 41 and 42, respectively, for connecting said manifold 40 with the not shown branched circuit pipes.

Practically, the drilling in the free end 19 of the boss 12 may be done at choice through the adjusting union 3 or trough the branch union 4 according to the position of said unions 3 and 4 with respect to one another.

According to the method proposed by the invention it is provided to carry out on a blank 1 made of hot-pressed bass beside the conventional machining steps of drilling, threading, and turning as in itself known for the known manifolds manufactured from bars the following phases:

i) a specific phase of removing the transverse diaphragm 11 for connecting both dead chambers 6 and 8 and forming said through duct 16 between the inlet port 17 and the outlet port 18, and

ii) a specific phase of simultaneously drilling of the adjusting union 3 and, through the tubular body 2, the projecting part or boss 12 in order to reach the dead hole 28 of the branch union 4 for forming the interception port 32 co-operating with the shutter 34.

The shown shutter means or mechanism 34 with a control knob 36 are known and, therefore, they are not described in more details.

Operation

The opening/closing operation of the branch circuit formed between the through duct 16 and the hole 28 of the branch union 4 and connected to the associated not shown branched circuit is in itself similar to the operation of the known manifolds.

As to the assembling of composite manifolds 40 according to the invention, from the above description and the FIGS. 7 to 13 is clearly inferable that a modular single-couple element 21 is connected by screwing to another module 21, as shown in FIG. 13, whereby the gasket or O-ring 26 assure the necessary tightness between said two modules 21. A composite or modular manifold 40 can have a desired number of single-couple modules 21.

Advantageously, according to the invention it will be possible, on the one hand, to keep in stock only one type of modular elements 21 and, on the other hand, to assemble the desired composite manifold 40 without the need of additional fixing means.

In order

to reduce the manifold assembling time,

to assemble the manifolds without using tools,

to provide a lower loss of pressure in the manifold due to friction,

to allow a direct connection between the manifolds and the pipes of the heating or sanitary system associated therewith, and

to allow a quick fixing of the branched circuit pipes into the manifold unions,

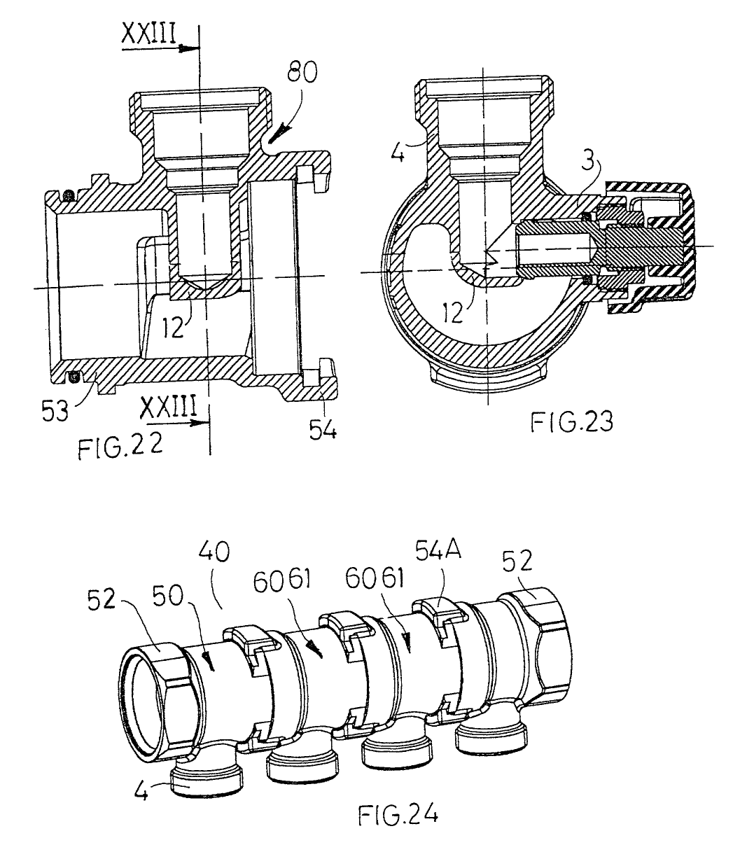

the present invention propose the further module embodiments which are shown in FIGS. 14 to 24 and are described in the following in more details.

Also the following described manifold module embodiments may be produced starting from metal blanks produced according to the invention as stated above and having a shape similar to the module subsequently obtained therefrom by chip-forming machining.

In comparison with the embodiment shown in FIGS. 7, 8, 9, 10, 11 and 13 the following module embodiments shown in FIGS. 14 to 24 have substantially the following differences:

a) at one end is provided a coupling means, which is integrally formed with the module body. This requires that for each manifold two end modules types are needed, whereas for manifolds having three or more branched circuits correspondingly one or more middle or basis modules of a third type are necessary, and/or

b) at the other module end is provided a quick coupling means for connecting together two adjacent manifold modules, and/or

c) the module body has a free internal cross section, that is without any internal projecting part or boss.

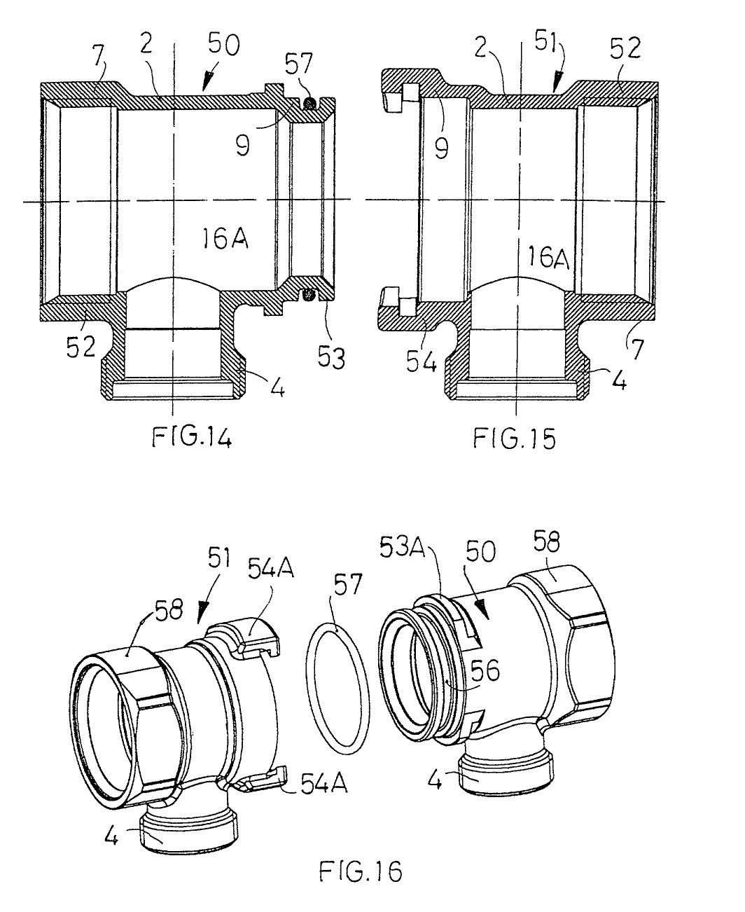

Whit reference to FIGS. 14 and 15 there is shown a left and a right end modules 50 and 51, respectively, having a substantially tubular module body 2 with an integrally formed branch union 4 and an end female threaded coupling 52 allowing a direct screw connection with a not shown heating or sanitary system pipe.

At the other internal end said modules 50 and 51 are provided whit a male and female quick coupling 53 and 54, respectively. In the shown example, said quick couplings 53 and 54 are designed like bayonet couplings, whereby a groove or seat 56 for a gasket or O-ring 57 is provided in said male quick coupling 53. The cam-like profiles of the male and female bayonet sectors 53A and 54A are such that a relative turning of, for example, 90° of the abutted bayonet couplings 53 and 54 leads to a firm and hermetic connection between two adjacent end modules 50 and 51, respectively. The numeral 58 denotes an external hexagonal nut configuration which is engageable by a not shown fork wrench.

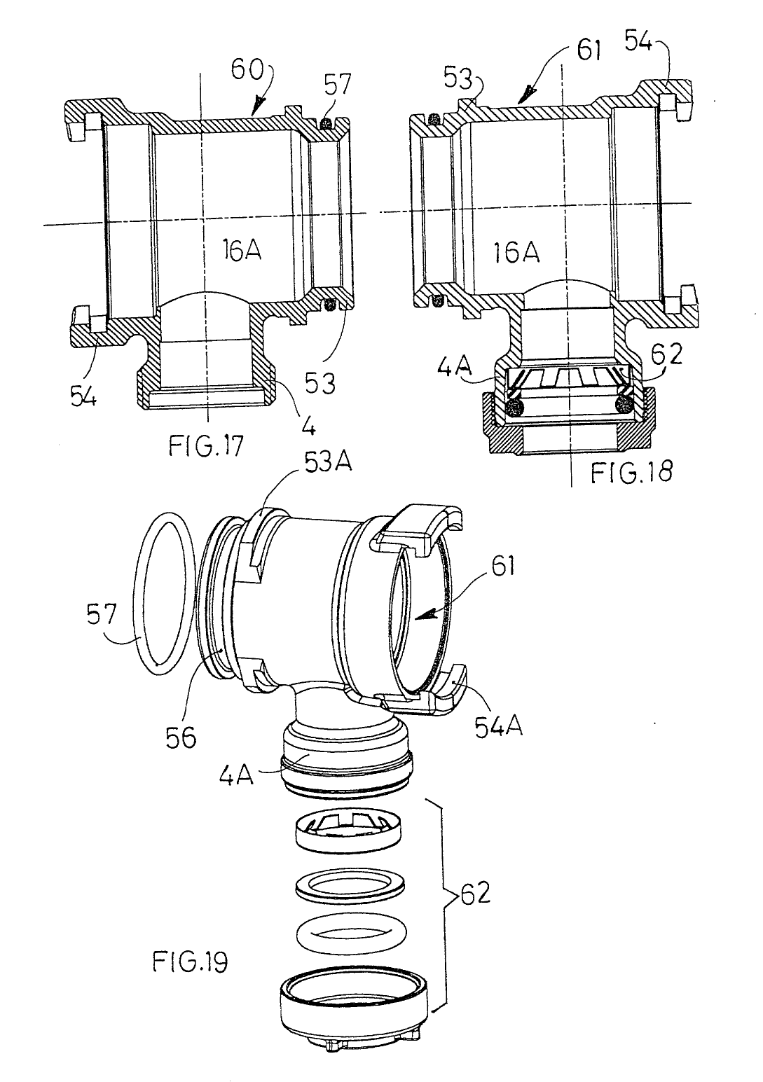

The middle or basis module for assembling manifolds having three or more branched circuits is denoted by 60 and it differs from the end modules 50 and 51 because it is provided at both module ends 7 and 9 with a quick male and female bayonet-like coupling 53 and 54, respectively, FIG. 17.

The branch union 4A, as shown in FIGS. 18 and 19, is designed in order to housing a known pipe fixing means 6, for example for metal pipes, plastics pipes, multilayer pipes and so on, allowing a quick fixing of the latter when inserted into said branch union 4A.

This measure may also be contemplated in the embodiment of the end modules 50 and 51, respectively, FIGS. 14, 15 and 16.

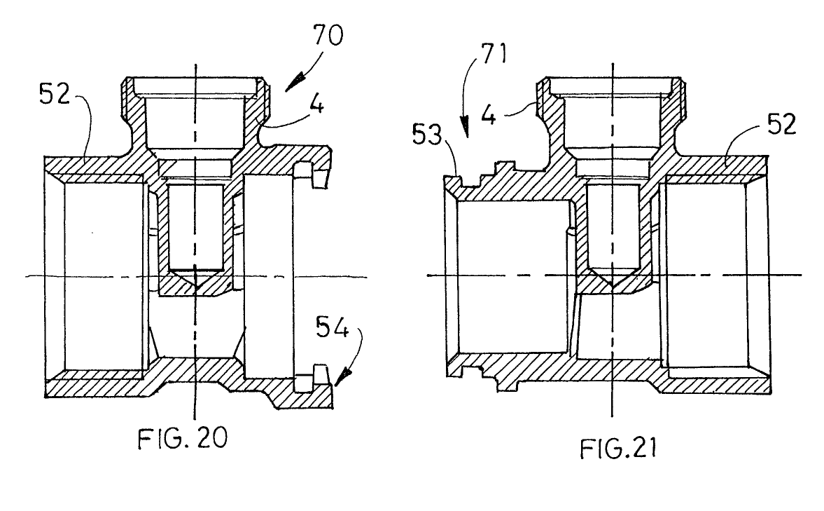

The module embodiments 70, 71 and 80 shown in FIGS. 20 to 23 differ in priciple from those shown in FIGS. 14 to 19 only for the fact that the module body 2 is provided with an internal boss 12 and a union couple 3 and 4, like the module embodiment 21, FIG. 7.

The branch union 4 could also be formed like the branch union 4A, that is for housing a fixing means 62 for metal pipes, plastic pipes, composite or multilayer pipes and the like.

In order to intensely reduce the loss of pressure due to the friction and indirectly to achieve a better sizing of the pipes of the heating or sanitary systems as well as a better efficiency of the latter, in the module embodiments shown in FIGS. 14 to 19 is according to the invention is not provided any boss 12 and both the first and the second cup-like end chambers 6, 8 and said the latter connecting duct 12 have substantially the same internal diameter, so that inside the module body 2 a substantially cylindrical through duct 16A is obtained.

Other structural features of said manifold modules 70, 71 and 80 may be inferred from the FIGS. 7 to 13 and the above description thereof. Another aspect of the present invention is that in the adjusting union 3 housing the shutters 34 may also be housed a flowmeter and the like or a thermostatic element or head which automatically control the shutter 34. Two composite manifolds 40 each formed with four single-circuit modules 50, 51, 60 or 61 and 70, 71, 80, respectively, are shown in FIGS. 27 and 28, respectively.

According to the invention also different types of manifold modules, as for example, 50, 51, 60, 61, 70, 71, 80, having the same coupling means may be assembled together to form a respectively desired manifold 40. Further, according to the present invention all the above described module embodiments may also be made of plastics and produced by injection molding or the like, especially for the use in systems handling corrosive fluids.

From the above structural and functional description of the modular or composite manifolds, the blanks 1, the method for producing the latter, and the modular elements 21, 50, 51, 60, 70, 71, 80, made of metal or plastics, it is inferable that with the teachings of the invention it is possible to efficiently achieve the objects set fort and to obtain the above mentioned advantages.

It will be understood that those skilled in the art could easily replace the shown threaded or bayonet-like quick coupling means by different designed or equivalent quick coupling means, as well as combine at will in the manifold modules the shown and described features without leaving the teachings and scope of the present invention as claimed.

1. Improved modular manifold for heating and sanitary systems composed of modular elements which are removably connected together, characterized in that it (40) comprises at least two manifold end modules (21; 50, 51; 70, 71) having each a substantially tubular one-piece module body (2) comprising
i) at least one branch union (4) for connecting a branched circuit,
ii) a first module end (7) adapted for the connection with an associated pipe of the heating or sanitary system,
iii) a second module end (9) provided with a quick coupling means (23; 53, 54) for a male/female coupling with the other end module (21; 50, 51; 70, 71),
iv) a sealing means (26; 57) housed in the male coupling means (23; 53, 54) in the respective end module (21; 50, 51; 70, 71):

2. Improved modular manifold according to claim 1, characterized in that it (40) further comprises one or more middle modules (60, 61; 80) having a substantially tubular one-piece module body (2) comprising
i) at least one branch union (4) for connecting a branched circuit, and
ii) end couplings means (53, 54) formed, at one module end, by a quick female coupling means (54) and, at the other module end, by a quick male coupling means (53) housing a sealing means (57).

3. Improved modular manifold according to claims 1 and 2, characterized in that said manifold end modules (21; 50, 51; 70, 71) and middle modules (21; 60, 61, 80) are further provided with an adjusting union (3) for housing a known adjusting shutter mechanism (34).

4. Improved modular manifold according to claims 3, characterized in that the axes of the branch and adjusting unions (3, 4) form a right angle and are placed in a common plane (15) which is orthogonal to the module longitudinal axis (20).

5. Improved modular manifold for heating and sanitary systems composed of modular elements which are removably connected together, characterized in that it (40) is formed by a plurality of equal basic manifold modules (21) having each a substantially tubular one-piece body (2) comprising
i) at least one branch union (4) for connecting a branch circuit,
ii) end coupling means formed, at one module end (9), by a male threaded coupling means (23) and, at the other module end (7), by a female threaded coupling means (22),
iii) a seat (24) in said male threaded coupling means (23) for housing a sealing means (26).

6. Improved modular manifold according to claim 5, characterized in that said basic modules (21) are further provided with an adjusting union (3).

7. Improved modular manifold according to claim 6, characterized in that the axes of the branch and adjusting unions (4,3) form a right angle and are placed in a common plane (15) which is orthogonal to the module longitudinal axis (20).

8. Improved modular manifold according to claims 5 to 7, characterized in that both manifold ends (7, 9) are provided with a locking nut (41, 42) the design of which permits a connection with a pipe of the heating or sanitary system having an internal diameter substantially equal to the manifold internal diameter.

9. Improved modular manifold according to claims 1 to 7, characterized in that the branch unions (4A) are adapted to house known fixing and sealing means (62) for a quick fixing of the branched circuit pipe.

10. Improved modular manifold according to claims 1 to 9, characterized in that the modules (21; 50, 51, 60, 61; 70, 71, 80) forming a modular manifold (40) are provided with branch (4) and/or adjusting (3) unions for connecting only one branched circuit.

11. Improved modular manifold according the claims 1 to 10, characterized in that the adjusting union (3) of at least a part of the manifold modules (21; 50, 51, 60, 61; 70, 71, 80) house a flowmeter with incorporated shutter mechanism (34), a thermostatic element controlling the shutter mechanism (34), or similar circuit components.

12. Improved modular manifold according to claims 1 to 11, characterized in that it (40) comprises manifold modules (50, 51, 60, 61; 70, 71, 80) of different types and materials, such as brass and plastics.

13. Improved manifold modules for assembling composite manifold for heating and sanitary systems according to one or more of the claims 1 to 12, characterized in that
in said tubular one-piece module body (2) is integrally provided an internal boss (12) diametrically extending from said branch union (4) beyond the longitudinal middle body axis (20),
in that between the free end (19) of said internal boss (12) and the diametrically opposite body wall is provided a through duct (16) connecting said cup-like chambers (6, 8) in said body ends (7, 9),
in that said internal boss (12) is positioned very close with respect to the bottom of a cup-like chamber (8), and
in that in said internal boss (12) is obtained a longitudinal through hole (28) opening at one end into said branch union (4) and, at the other end, inside the body (2) with a port (32) functionally co-operating with the active end of a mechanism shutter (34) housed in said adjusting union (3) (FIGS. 7; 20 to 25), or
in that no boss (12) is provided inside said module body (2), and
in that said first and second end chambers (6, 8) and said through duct (16) have substantially the same diameter, so that inside the module body (2) is provided a substantially cylindrical through duct (16A) connecting said body ends (7, 9) (FIGS. 14 to 19).

14. Improved modules according to claim 13, characterized in that said modules (21; 50, 51, 60, 61; 70, 71, 80) are made of metal, such as brass, obtained by chip-forming machining a correspondingly designed hot-pressed blank (1).

15. Improved modules according to claim 13, characterized in that said modules (21; 50, 51, 60, 61; 70, 71, 80) are made of plastics and are produced, for example, by injection molding.

16. Blanks made of metal, for example brass, for producing modules for assembling modular manifolds for heating and sanitary systems according to one or more of claims 1 to 12, characterized in that the starting semi-manufactured piece, for example in the form of a cylindrical massive or tubular piece, is submitted to an hot-pressing step and thereby shaped such that it comprises:
in a first body end (7), a first substantially cup-like chamber (6) opening outwards and, in a second body end (9), a second cup-like chamber (8) opening outwards, which chambers (6, 8) are separated by a thin diaphragm (11), and
in one cup-like chamber (6), between said diaphragm (11) and a dead branch union (4), an integrally formed and inside projecting part or boss (12), which diametrically extends from said branch union (4) beyond the longitudinal middle axis (20) of said blank (1),
in that said diaphragm (11) is provided offset with respect to the middle axis (14) of said dead branch union (4),
in that orthogonally to said dead branch union (4) as well as to the longitudinal axis (20) of the tubular body (2), or co-axially and diametrically opposite to said dead branch union (4), is provided a dead adjusting union (3), and
in that said dead unions (3, 4) lie in a common plane (15) which is transversal with respect to the longitudinal blank axis (20), or
in that said hot-pressed blank body (2) has a substantially cylindrical configuration and has only one branch dead union (4) or a branch (4) and a dead adjusting (3) union couple, which latter (3, 4) are provided either diametrically opposite or orthogonally to one another and project from said blank body (2) outwards.

17. Blanks for producing manifold modules according to claim 16, characterized in that both end chambers (6, 8) are co-axial,
in that said internal boss (12) also extends longitudinally inside the blank body (2), and
in that both dead branch and adjusting unions (3, 4) project from the blank body (2).

18. Blanks for producing manifold modules according to claims 16 and 17, characterized in that the thickness of the module tubular wall is in the range of 2-4 mm, and
in that said module tubular wall has a substantially step-like configuration or it is substantially cylindrical.

19. Blanks for producing manifold modules according to claim 16, characterized in that the position of said diaphragm (11) is such that a removing thereof establishes a through duct (16) forming a fluid communication between said inlet (17) and outlet (18) ports of the blank body (2).

20. Method for manufacturing blank modules to form manifold modules and modular manifolds, according to one or more of claims 1 to 15, characterized in that starting massive or tubular pieces, for example made of brass, are first hot-pressed the shape the latter in a configuration according to claims 16 to 19, and then machined by in itself known chip-forming machining steps like turning, drilling and so on, further comprising the following machining steps:
i) a specific step for removing the transverse diaphragm (11) for connecting together both blank end chambers (6, 8) and forming said through duct (16) between the blank inlet port (17) and outlet port (18), and
ii) a specific step of simultaneously drilling the dead adjusting union (3) and, through the tubular body (2), the projecting part or boss (12) in order to reach a dead hole (28) made in said dead branch union (4) for forming in said dead hole (28) an interception port (32) provided for a functional operation with the control shutter (34).
